(19) United States
(12) Patent Application Publication
(10) Pub. No.: US 2007/0087107 A1
(43) Pub. Date: Apr. 19, 2007

(54) Food products containing legume products and processes for producing the food products

(75) Inventors: Cheryl K. Borders, Moweaqua, IL (US); Michael J. Fleckenstein, Decatur, IL (US); William W. Fletcher, Decatur, IL (US)

Correspondence Address: ARCHER DANIELS MIDLAND COMPANY, 4666 FARIES PARKWAY, DECATUR, IL, 62526, US

(73) Assignee: Archer Daniels Midland Company

(21) Appl. No.: 11/581,256

(22) Filed: Oct. 13, 2006

Related U.S. Application Data
(60) Provisional application No. 60/726,263, filed on Oct. 13, 2005.
(60) Provisional application No. 60/791,769, filed on Apr. 13, 2006.

(51) Int. Cl. A23L 1/20

(52) U.S. Cl. 426/634

(57) ABSTRACT

Food products containing legume products, as well as processes for producing the food products are disclosed.

### CROSS-REFERENCE TO RELATED APPLICATIONS

This application claims the benefit of U.S. Provisional Application No. 60/726,263, filed Oct. 13, 2005, and U.S. Provisional Application No. 60/791,769, filed Apr. 13, 2006, each of the contents of the entirety of which are incorporated by this reference.

### TECHNICAL FIELD

The present invention relates generally to food technology, and more particularly, to food products containing legume powders.

### BACKGROUND

In the United States, there is increasing concern over the consumption of high sugar and high fat foods by the population. In fact, in 2005, the US government revised the Dietary Guidelines for food consumption in the United States. One of the goals of the revision of the Dietary Guidelines is to stop the alarming increase in obesity among the youth in the United States as too many children are overweight due to a lack of exercise and poor eating habits. One problem in children's diets is that if the school aged children do not care for the food being offered at school cafeterias, the children are able to obtain a foodstuff such as a candy bar, or other high sugar or high fat snack out of a vending machine located at the school. Thus, some children's diets may become focused on high sugar or high fat foodstuffs.

In the 2005 Dietary Guidelines Pyramid, beans and peas are listed under both the Vegetables and, the Meats and Beans categories, thus, emphasizing the healthy nature of legumes in the diet. As a further sign of a growing emphasis in the United States on healthier diets and the problem of obesity in the US population, California has passed legislation mandating that healthier snacks be provided to children at vending machines in schools in an attempt to limit the sugar and fat consumed by the children.

In addition to the emphasis on lower fat and lower sugar diets, other beneficial effects of legumes are becoming apparent. For instance, inositol polyphosphates, which are naturally occurring substances found in most legumes, have been implicated in being able to inhibit the growth of some cancer xenografts. (See, Cancer Resources, 2005; 65: (18), Sep. 15, 2005).

The danger of high sugar or high fat diets in children is also being seen outside of the United States. For instance, in Great Britain, the British government has taken proactive measures to deal with the issue of childhood obesity by regulating food in school cafeterias and vending machines located at schools. Junk foods high in fat, salt or sugar will be banned from school cafeterias and vending machines will only be allowed to provide healthy fares. Government officials in Canada are also addressing the rapid rise in childhood obesity and are looking at limiting the sale of chocolate bars, other candy and pop in elementary school vending machines.

With the passage of laws and regulations requiring healthier foods and snacks be provided in schools, as well as an increased awareness of the health benefits of legumes, there exists a need for healthier food products and foodstuffs that provide the beneficial nutritional effects of legumes.

### SUMMARY OF THE INVENTION

In each of its various embodiments, the present invention helps fulfill these needs and discloses healthier food products and processes for producing them.

In one embodiment, a composition of the present invention comprises a dehydrated legume product having an increased amount of dietary fiber on a dry weight basis as compared to a legume from which the dehydrated legume product originates and a flour, a meal, or the flour and the meal. The dehydrated legume product and the flour, the meal or the flour and the meal are present in the composition in such amounts and processed such that the composition takes the form of a crisp or a puff.

In another embodiment, a process for producing a product includes admixing a dehydrated legume product with an ingredient, thus producing a mixture and extruding the mixture through a die such that a crisp or a puff is formed.

In yet another embodiment, an extruded food product consists essentially of a dehydrated bean powder and an ingredient selected from the group consisting of a wheat flour, a rice flour, a corn meal, a corn masa, and any combinations thereof. The extruded food product has a density of between 50 grams per liter to about 250 grams per liter.

In a further embodiment, a composition consists essentially of a dehydrated bean powder having an increased amount of dietary fiber on a dry weight basis as compared to a legume from which the dehydrated bean powder originates, wherein the dehydrated bean powder is processed such that the composition takes the form of a crisp or a puff.

In one embodiment, an extruded product comprises a dehydrated legume powder or a dehydrated legume flour.

In another embodiment, a process for producing a food product includes admixing a dehydrated legume product with an ingredient, forming a dough or batter from the dehydrated legume product and the ingredient, and shaping the dough or batter into the food product.

In a further embodiment, another food product is disclosed. A calorie containing portion of the food product consists essentially of a dehydrated legume product, and another ingredient.

In yet an additional embodiment, an extruded product comprises a legume product, wherein the legume product has an increased amount of dietary fiber as compared to a powder or a flour from a non-processed or raw legume.

In yet a further embodiment, an extruded product comprising an isolated or purified nutraceutical and a dehydrated legume product is disclosed.

In another embodiment, a extruded product includes a dehydrated legume product and a corn product

### BEST MODE OF THE INVENTION

Food products containing legume powders or other dehydrated legume products, as well as processes for producing the food products are disclosed. Foodstuffs including legumes or legume products are typically high in fiber and/or protein as compared to the foodstuff not including the legume or legume product. Thus, the incorporation of legumes or legume products into a foodstuff results in a foodstuff having a higher content of fiber and/or protein, while reducing the sugar and/or fat content of the foodstuff. In one embodiment, less than 35% of the calories present in a food product produced using the processes of the present invention are calories from fat, and in another embodiment, less than 10% of the calories are from a saturated fat.

In one embodiment, a food product or ingredient used in a foodstuff comprises a legume powder. The presence of the legume powder in the foodstuff enhances or increases the amount of fiber and/or protein in the foodstuff, thus, helping a person consuming the foodstuff to meet their Dietary Guidelines for fiber and/or protein intake. In another embodiment, distribution of the foodstuff having the enhanced or increased fiber and/or protein to a population may help increase the nutrition of the population and, potentially, help lower incidences of obesity or other diet related diseases.

In one embodiment, the legume from which the legume powder originates may be of a Phaseolus species (i.e., beans). In other embodiments, the legume may comprise green or yellow peas (i.e., Pisum), lentils (i.e., Lens vulgaris), chickpeas (i.e., Cicera arietenum), soybeans (i.e., Glycine max), peanuts, (i.e., Arachis hypogaea), trefoil (i.e., Lotus corniculatus), and combinations of any thereof. In further embodiments, varieties of beans that may be used to produce the foodstuffs of the present invention include, without limitation, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed beans, Garbanzo beans, Cranberry beans, White Beans, Rice beans, Butter beans, African Giraffe beans and any combinations thereof.

In various embodiments, a food product or ingredient of the present invention may take various forms including, but not limited to, a dough, a batter, chip, crisp, cracker, cereal piece, cookie piece, snack food, nugget, flaked product, a wafer or any combinations thereof. In one embodiment, the food product produced using the processes of the present invention comprises a crisp or a puff and has a density of between about 50 grams per liter to about 250 grams per liter. Further, the food product or ingredient may be incorporated into a foodstuff in combination with one or more seasonings or spices in order to enhance the flavor of the foodstuff. In yet other embodiments, processing aids or preservatives may be added to the food product or ingredient in order to affect the functionality and shelf life of the foodstuff.

In yet additional embodiments, other ingredients such as food colorants, vitamins, minerals, edible oils or fats, emulsifiers, leavening agents, natural or artificial sweeteners, starches, thickening agents, fiber (including, but not limited to, a soluble fiber (i.e., FIBERSOL or INULIN) or an insoluble fiber), a cellulose (i.e., microcrystalline cellulose or carboxymethylcellulose), maltodextrins, corn-syrup solids, potato starch, corn starch, wheat starch, tapioca starch, a vegetable product, a fruit product, a nut product or combinations of any thereof may be used in conjunction with the foodstuff of the present invention.

In an additional embodiment, a process for producing a food product or ingredient includes combining a legume powder or other dehydrated legume product with at least one other ingredient and water to produce a mixture (i.e., such as a dough or a batter), subjecting the resulting mixture to heat and/or pressure, and, optionally, extruding or shaping the resulting mixture to form a foodstuff. In one embodiment, the legume powder may be a dehydrated legume powder. An extrusion process may be used to subject the food product or ingredient to pressure such that upon exposure to the atmosphere and, thus, a lower pressure upon leaving the extruder, the food additive or ingredient expands and cools producing a puffed product having any desired shape depending on the size and shape of the die used in the extruder. As known by those of ordinary skill in the art, the cutting frequency of the extruded product upon exiting the die may be determined using routine experimentation to obtain the desired shape and/or size.

In a further embodiment, a process for producing a food product or ingredient includes combining a legume powder or legume product with at least one other ingredient and water to produce a mixture such as, for example, a dough or batter. The mixture may be sheeted and cut into a desired shape including, but not limited to, a round, a strip or a triangle. In one embodiment, the sheeting may be performed by passing the dough or batter through a press or roller, and cutting the mixture into a desired shape may be performed by using a die or stamp having the desired shape that is associated with the press or roller. The food product or ingredient may optionally be fried in an edible oil, baked or a combination thereof.

The legume powder or product may be produced by milling a legume or legume product. In another embodiment, a dehydrated legume product may be used to form the legume powder, and be produced by milling a dehydrated legume or the dehydrated legume product into a powder.

In one embodiment, the dehydrated legume or dehydrated legume product is produced using the process described in US Patent Application 2005/0095346 assigned to Archer-Daniels-Midland Company of Decatur, Ill., entitled Process for the Production of Reconstitutable Bean Products published May 5, 2005, the contents of the entirety of which is incorporated by this reference. In another embodiment, the process for dehydrating the legume or legume product may include blanching the legume or legume product, cooking the blanched legume or legume product, and/or dehydrating the cooked legume or legume product to form a dehydrated or reconstitutable legume or legume product. In a further embodiment, water may be used to blanch and/or cook the legumes or legume products, and an organic acid may optionally be added to the blanching water, the cooking water, or both.

In other embodiments, the process for producing the dehydrated legume or dehydrated legume products includes conditioning the legumes or legume products by subjecting the legumes or legume products to hydration; cooking the legumes or legume products; depressurizing the cooked legumes or legume products; and/or dehydrating the legumes or legume products to form a reconstitutable legume or legume product. In other embodiments, the process for dehydrating the legume or legume product may also include use of an organic acid in the hydration, blanching, and/or cooking step, and the process may further include washing and/or destoning raw legumes used in the process.

In a further embodiment, a dehydrated legume, a dehydrated legume flour, a dehydrated legume powder or a dehydrated legume product used in the foodstuffs of the present invention has an increased dietary fiber percentage on a weight basis as compared to a non-dehydrated or raw legume, flour, powder or product. For example, dehydrated Pinto beans comprise about 27% dietary fiber, while non-dehydrated or raw Pinto beans comprise about 12% dietary fiber; dehydrated Small Red beans comprises about 23% dietary fiber, while non-dehydrated or raw Small Red beans comprise about 8.9% dietary fiber; dehydrated Black beans comprise about 29% dietary fiber, while non-dehydrated or raw Black beans comprise about 13.3% dietary fiber; dehydrated Navy beans comprise about 23% dietary fiber, while non-dehydrated or raw Navy beans comprise about 9.8% dietary fiber; dehydrated Dark Red Kidney beans comprise about 24% dietary fiber, while non-dehydrated or raw Light Red Kidney beans comprise about 10.6% dietary fiber; and dehydrated Light Red Kidney beans comprise about 24% dietary fiber, while non-dehydrated or raw Light Red Kidney beans comprise about 10.6% dietary fiber. It will be apparent by those of ordinary skill in the art that the amounts and percentages of dietary fiber in a legume or legume product may vary depending on various factors and that the amounts of fiber discloses herein are exemplary in nature.

In another embodiment, a dehydrated legume or legume product is subjected to a milling process to produce a dehydrated legume powder. In a further embodiment, the dehydrated legume or legume product is subjected to a form of crushing or pulverizing such as by passage of the dehydrated legume or legume product through a hammermill or universal mill. In one embodiment, the dehydrated legume or legume product is ground in a PC-20 mill. The ground or powdered dehydrated legume or legume product may be passed through a Swecoscreen 60 mesh, wherein the ground or powdered dehydrated legume or legume product has a particle size of less than about 0.250 mm. In another embodiment, the ground or powdered dehydrated legume product are produced such that about 95% of the ground or powdered dehydrated legume product passes through an 80 mesh screen. The ground or powdered dehydrated legume or legume product may further be passed by a magnet to remove any metallic (i.e., iron-containing) contaminants, and further be placed in containers for shipping or placed in a food product.

In one embodiment, a food product or ingredient for use in a foodstuff comprises a dehydrated legume powder and another ingredient such as, for example, a flour or a meal. Non-limiting examples of crops that may be used to produce the flour or meal to be used in combination with the dehydrated legumes, without limitation, include corn, rice, whole wheat, barley, durum, sorghum, sunflower, canola, oats, flax, potatoes, buckwheat and combinations of any thereof (i.e., such as a multigrain product).

In other embodiments, various ingredients may be added to the foodstuff in combination with the dehydrated legume powder or the dehydrated legume flour, and other ingredients such as flour or meal. Examples of such various ingredients include, but are not limited to, proteins such as wheat protein, wheat protein isolate, wheat gluten, buttermilk solids, whey protein, whey protein isolate, milk powders, egg protein, canola protein, pea protein, wheat protein, potato protein, corn protein, sesame protein, sunflower protein, cottonseed protein, copra protein, palm kernel protein, safflower protein, linseed protein, peanut protein, lupin protein, oat protein, soy protein, soy protein concentrates, soy protein isolates and mixtures of any thereof. Other ingredients that may be added to the foodstuff include, but are not limited to, texture modifiers such as, for example, calcium carbonate.

In further embodiments, the foodstuff may take the form of, without limitation, a breakfast cereal, snack bar, a snack chip, nutrition bar, breakfast bar, candy, meat substitute, bread or breading substitute, animal food, a puffed snack (i.e., puffed curl, puffed ball or other puffed shape), crunchy curl, chip, tortilla chip, extruded curl, corn chip, multigrain chip, multigrain snack, flat bread, biscuit, crispbread, protein inclusion, cone, cookie, flaked product, fortune cookie, pasta, rice cake, puffed wheat cake, maize cake, or other known foodstuff.

In other embodiments, a pre-cooked or dehydrated legume product having utility in the embodiments of the present invention may include, without limitation, a sugar and/or calcium chloride. Non-limiting examples of such legume products are disclosed in Table 1. Other legume products that may be used in the embodiments of the present invention are disclosed in Table 2. The legume products of Tables 1 and 2 are commercially available from Archer Daniels Midland Company of Decatur, Ill.

TABLE 1
Nutritional analysis of bean powders.

| | | | Small | | Great |
|---|---|---|---|---|---|
| | Pinto | Black | Red | Navy | Northern |
| Per 100 | Bean | Bean | Bean | Bean | Bean |
| grams | Powder | Powder | Powder | Powder | Powder |
| Calories | 299 | 311 | 304 | 305 | 319 |
| Calories from | 20 | 20 | 17 | 23 | 20 |
| fat | | | | | |
| Calories from | 5 | 4 | 4 | 5 | 4 |
| Saturated fat | | | | | |
| Fatty Acid | | | | | |
| Profile | | | | | |
| Total Fat (g) | 2.27 | 2.27 | 1.88 | 2.55 | 2.27 |
| Saturated Fat | 0.5 | 0.48 | 0.43 | 0.52 | 0.49 |
| (g) | | | | | |
| Monosaturated | 0.26 | 0.32 | 0.14 | 0.34 | 0.26 |
| Fat (g) | | | | | |
| Cis/cis | 1.41 | 1.37 | 1.23 | 1.58 | 1.42 |
| polyunsaturated | | | | | |
| fat (g) | | | | | |
| Trans Fat (g) | 0 | 0 | 0 | 0 | 0 |
| Carbohydrate, | 65 | 66.4 | 68.4 | 64.1 | 64 |
| Total (g) | | | | | |
| Carbohydrate, | 46.6 | 50.3 | 51.0 | 46.2 | 50.1 |
| Available (g) | | | | | |
| Total Dietary | 24.7 | 22.2 | 24.0 | 26.4 | 19.9 |
| Fiber (g) | | | | | |
| Insoluble fiber | 18.4 | 16.1 | 17.4 | 17.9 | 13.9 |
| Soluble fiber | 6.3 | 6.1 | 6.6 | 8.5 | 6.0 |
| Sugars (HPLC), | | | | | |
| in (g) | | | | | |
| Fructose | 0 | 0 | 0 | 0 | 0 |
| Glucose | 0 | 0 | 0 | 0 | 0 |
| Sucrose | 3.84 | 3.64 | 2.39 | 4.02 | 3.66 |
| Maltose | 0 | 0 | 0 | 0 | 0 |
| Lactose | 0 | 0 | 0 | 0 | 0 |
| Raffinose | 0.21 | 0.26 | 0.35 | 0.33 | 0.25 |
| Stachyose | 2.28 | 2.00 | 2.91 | 2.53 | 2.08 |
| Protein (g) | 23.1 | 22.4 | 20.8 | 24.4 | 24.6 |
| Vit A Retinol | 100 | 100 | 100 | 100 | 100 |
| (IU) (less than) | | | | | |
| Vit C Total (mg) | 2.56 | 3.1 | 2.98 | 3.16 | 3.04 |
| Vit E (IU) | 0.1 | 0.1 | 0.1 | 0.1 | 0.1 |
| (less than) | | | | | |
| Vit B1 (Thiamin) | 0.2 | 0.4 | 0.31 | 0.27 | 0.19 |
| (mg) | | | | | |
| Minerals and | | | | | |
| Metals | | | | | |
| Sodium (mg) | 37.2 | 43.6 | 29.0 | 27.1 | 30.7 |
| Potassium (mg) | 919 | 927 | 1080 | 1000 | 750 |
| Calcium (mg) | 197 | 292 | 188 | 259 | 310 |
| Magnesium (mg) | 130 | 121 | 103 | 126 | 125 |
| Phosphorus (mg) | 403 | 440 | 417 | 520 | 481 |
| Folic Acid, | 76.4 | 107 | 132 | 132 | 127 |
| Total (μg) | | | | | |
| Zinc (mg) | 2.66 | 2.52 | 2.37 | 2.01 | 2.27 |
| Iron (mg) | 5.17 | 5.45 | 5.87 | 5.15 | 5.22 |
| Copper (mg) | 0.715 | 0.773 | 0.628 | 0.936 | 0.625 |
| Niacin (mg) | 1.02 | 1.52 | 1.39 | 1.49 | 1.51 |
| Moisture (%) | 6.91 | 5.99 | 5.98 | 5.79 | 6.43 |
| Ash (%) | 2.766 | 2.959 | 2.950 | 3.160 | 2.745 |
| Cholesterol (mg) | 0 | 0 | 0 | 0 | 0 |

TABLE 2
Properties of bean products.

| | Moisture | Protein | Dietary | Fat | Carbohydrates | Calories per |
|---|---|---|---|---|---|---|
| Bean Type | (%) Max | (%) | Fiber (%) | (%) | (%) | 100 grams |
| Pinto Bean powder | 9.5 | 22.3 | 23.0 | 1.8 | 63.1 | 292 |
| Black Bean powder | 9.5 | 24.6 | 22.2 | 2.0 | 65.6 | 321 |
| Small Red Bean powder | 9.5 | 23.6 | 22.5 | 1.8 | 67.2 | 323 |
| Navy Bean powder | 9.5 | 22.3 | 27.7 | 2.0 | 64.8 | 367 |
| Great Northern Bean powder | 9.5 | 23.0 | 22.3 | 2.2 | 67.4 | 325 |
| Dark Red Kidney Bean pieces | 9.5 | 23.3 | 23.8 | 1.6 | 62.1 | 356 |
| Light Red Kidney Bean pieces | 9.5 | 23.3 | 23.8 | 1.6 | 62.1 | 356 |
| White Kidney Bean pieces | 9.5 | 25.3 | 23.8 | 1.8 | 61.7 | 298 |
| Pink Bean pieces | 9.5 | 21.0 | 12.7 | 1.1 | 64.2 | 343 |
| Mayocoba Bean pieces | 9.5 | 26.5 | 19.8 | 1.9 | 62.9 | 320 |

The invention is further explained by use of the following illustrative EXAMPLES.

### EXAMPLES

### Example 1

An extruded food product was prepared as follows. 75% corn meal was mixed with 25% dehydrated Navy Bean powder (including dehydrated Navy beans, sugar and calcium chloride), and the resulting mixture was blended for 10 minutes at ambient temperature in a Day Ribbon blender. The resulting mixture was introduced into a live bottom bin that feeds a Wenger TX 52 twin screw extruder. The extruder conditions used to prepare the extruded food product were as follows:

| | |
|---|---|
| Extruder RPM | 330 |
| Cylinder RPM | 160 |
| Feeder RPM | 14 |
| % Load | 50 |
| Knife RPM | 310 |
| Zone temps inlet | 160° F. 150° F. 166° F. 234° F. 268° F. 254° F. |
| to outlet | |
| Water Addition | 165 ml (milli-liters)/minute |
| Die Pressure | 710 PSI |

The extruder screw profile was a combination of feed screws, and forward and reverse shearlocks. The resulting mixture was fed into the feed throat of the extruder at a rate of 75 lbs (pounds) per hour, and water was added to about 18%. The end die plate of the extruder was fitted with four 3 mm round dies and two circular cutting blades. The extrudate or collet coming out of the extruder was cut and resulted in puffs suitable for use in or as snack foods.

It will be apparent by those of ordinary skill in the art that conventional extruders other than a twin-screw extruder (i.e., a single screw extruder) may be used to extrude the food products of the present invention. In these other embodiments using other extruders, the conditions used for extrusion may be determined using routine experimentation.

Calculated nutritional values for the extruded food product of Example 1 are for 30 grams of the extruded product: 100 calories; 0.5 g of fat; 0 g of saturated fat; 0 g of trans fat; 0 mg of cholesterol; 5 mg of sodium; 22 g of total carbohydrate; 4 g of dietary fiber; less than 1 g of sugar; and 4 g of protein.

### Example 2

An extruded food product was prepared as follows. 50% corn meal was mixed with 50% dehydrated Navy Bean powder (including dehydrated Navy beans, sugar and calcium chloride), and the resulting mixture was blended for 10 minutes at ambient temperature in a Day Ribbon blender. The extrusion process and conditions were substantially the same as those described in Example 1. The extrudate or collet coming out of the extruder was cut and resulted in puffs suitable for use in or as snack foods.

Calculated nutritional values for the extruded food product of Example 2 are for 30 grams of the extruded product: 90 calories; 0.5 g of fat; 0 g of saturated fat; 0 g of trans fat; 0 mg of cholesterol; 5 mg of sodium; 21 g of total carbohydrate; 5 g of dietary fiber; less than 1 g of sugar; and 5 g of protein.

### Example 3

An extruded food product was prepared as follows. 25% corn meal was mixed with 75% dehydrated Navy Bean powder (including dehydrated Navy beans, sugar and calcium chloride), and the resulting mixture was blended for 10 minutes at ambient temperature in a Day Ribbon blender. The extrusion process and conditions were substantially the same as those described in Example 1. The extrudate or collet coming out of the extruder was cut and resulted in puffs suitable for use in or as snack foods.

Calculated nutritional values for the extruded food product of Example 3 are for 30 grams of the extruded product: 80 calories; 0.5 g of fat; 0 g of saturated fat; 0 g of trans fat; 0 mg of cholesterol; 5 mg of sodium; 20 g of total carbohydrate; 7 g of dietary fiber; 1 g of sugar; and 6 g of protein.

### Example 4

An extruded food product was prepared as follows. 55% whole wheat flour was mixed with 44% dehydrated Pinto Bean powder (including dehydrated Pinto beans, sugar and calcium chloride) and 1% calcium carbonate, and the resulting mixture was blended for 10 minutes at ambient temperature in a Day Ribbon blender. The extrusion process and conditions were substantially the same as those described in Example 1. The extrudate or collet coming out of the extruder was cut and resulted in puffs suitable for use in or as snack foods.

Calculated nutritional values for the extruded food product of Example 4 are for 30 grams of the extruded product: 90 calories; 0.5 g of fat; 0 g of saturated fat; 0 g of trans fat; 0 mg of cholesterol; 5 mg of sodium; 20 g of total carbohydrate; 5 g of dietary fiber; less than 1 g of sugar; and 5 g of protein.

### Example 5

An extruded food product was prepared as follows. 90% rice flour was mixed with 10% dehydrated Red Bean powder (including dehydrated small red beans, sugar and calcium chloride), and the resulting mixture was blended for 10 minutes at ambient temperature in a Day Ribbon blender. The resulting mixture was introduced into a live bottom bin that feeds a Wenger TX 52 twin screw extruder. The extruder conditions used to prepare the extruded food product were as follows:

| | |
|---|---|
| Extruder RPM | 350 |
| Cylinder RPM | 120 |
| Feeder RPM | 10 |
| % Load | 57 |
| Knife RPM | 3500 |
| Zone temps inlet | 153 F. 192 F. 212 F. 260 F. 254 F. 223 F. |
| to outlet | |
| Water addition | 215 ml/minute |
| Die Pressure | 1,000 PSI |

The extruder screw profile was a combination of feed screws, and forward and reverse shearlocks. The resulting mixture was fed into the feed throat of the extruder at a rate of 75 lbs (pounds) per hour, and water was added to about 18%. The end die plate of the extruder was fitted with two 1×3 mm slotted dies and six circular cutting blades. The extrudate or collet coming out of the extruder was cut and resulted in puffs suitable for use in or as cereals, cereal bars or other snacks.

Calculated nutritional values for the extruded food product of Example 5 are for 30 grams of the extruded product: 110 calories; 0.5 g of fat; 0 g of saturated fat; 0 g of trans fat; 0 mg of cholesterol; less than 5 mg of sodium; 24 g of total carbohydrate; 1 g of dietary fiber; less than 1 g of sugar; and 2 g of protein.

### Example 6

An extruded food product was prepared as follows. 75% rice flour was mixed with 25% dehydrated Red Bean powder (including dehydrated small red beans, sugar and calcium chloride), and the resulting mixture was blended for 10 minutes at ambient temperature in a Day Ribbon blender. The extrusion process and conditions were substantially the same as those described in Example 5. The extrudate or collet coming out of the extruder was cut and resulted in puffs suitable for use in or as cereals, cereal bars or other snacks.

Calculated nutritional values for the extruded food product of Example 6 are for 30 grams of the extruded product: 100 calories; 0.5 g of fat; 0 g of saturated fat; 0 g of trans fat; 0 mg of cholesterol; 5 mg of sodium; 23 g of total carbohydrate; 2 g of dietary fiber; less than 1 g of sugar; and 3 g of protein.

### Example 7

An extruded food product was prepared as follows. 90% corn meal was mixed with 10% dehydrated Red Bean powder, and the resulting mixture was blended for 10 minutes at ambient temperature in a Day Ribbon blender. The resulting mixture was introduced into a live bottom bin that feeds a Wenger TX 52 twin screw extruder. The extruder conditions used to prepare the extruded food product were as follows:

| | |
|---|---|
| Extruder RPM | 310 |
| Cylinder RPM | 160 |
| Feeder RPM | 12 |
| % Load | 50 |
| Knife RPM | 400 |
| Zone temps inlet | 180 F. 200 F. 200 F. 245 F. 270 F. 250 F. |
| to outlet | |
| Water addition | 155 ml/minute |
| Die pressure | 600 PSI |

The extruder screw profile was a combination of feed screws, and forward and reverse shearlocks. The resulting mixture was fed into the feed throat of the extruder at a rate of 75 lbs (pounds) per hour, and water was added to about 18%. The end die plate of the extruder was fitted with four 3 mm round dies and two circular cutting blades. The extrudate or collet coming out of the extruder was cut and resulted in puffs suitable for use in or as snack foods.

### Example 8

An extruded food product was prepared as follows. 90% corn meal was mixed with 10% dehydrated Pinto Bean powder (including dehydrated pinto beans, sugar and calcium chloride), and the resulting mixture was blended for 10 minutes at ambient temperature in a Day Ribbon blender. The extrusion process and conditions were substantially the same as those described in Example 7. The extrudate or collet coming out of the extruder was cut and resulted in puffs suitable for use in or as snack foods.

Calculated nutritional values for the extruded food product of Example 8 are for 30 grams of the extruded product: 100 calories; 0.5 g of fat; 0 g of saturated fat; 0 g of trans fat; 0 mg of cholesterol; less than 5 mg of sodium; 23 g of total carbohydrate; 3 g of dietary fiber; less than 1 g of sugar; and 3 g of protein.

### Example 9

An extruded food product was prepared as follows. 75% corn meal was mixed with 25% dehydrated Pinto Bean powder, and the resulting mixture was blended for 10 minutes at ambient temperature in a Day Ribbon blender. The extrusion process and conditions were substantially the same as those described in Example 7. The extrudate or collet coming out of the extruder was cut and resulted in puffs suitable for use in or as snack foods.

### Example 10

In yet an additional embodiment, a crisp having edible bean products and a nutraceutical was produced with the following formulation:

Formulation

| Ingredient | Percentage |
|---|---|
| White Corn Masa | 24.44 |
| Corn meal | 24.44 |
| Navy bean powder (dehydrated) | 29.33 |
| Whole wheat flour | 9.77 |
| Whole black beans (dehydrated) | 9.77 |
| Sterols (CardioAid M brand sterols). | 2.25 |

The ingredients of the formulation were blended in a ribbon blender and fed into a Wenger 52 mm twin screw extruder containing a mixture of feeding and kneading elements, as well as forward and reverse shear locks. The die of the extruder had 4 heart shaped openings and the extrudate was cut with a rotating knife. It will be apparent by those of ordinary skill in the art that a die with any shaped opening may be used.

The extrusion conditions were as follows:

| | |
|---|---|
| Extruder Screw RPM | 445 |
| PreConditioner RPM | 120 |
| Feeder RPM | 11 |
| | (about 60 lbs/hr) |
| % Motor Load | 32 |
| Rotating Knife RPM | 1100 |
| (two blades) | |

Extrusion temperatures, inlet to outlet in ° F.

| | |
|---|---|
| Zone 1 | 165 |
| Zone 2 | 185 |
| Zone 3 | 200 |
| Zone 4 | 235 |
| Zone 5 | 280 |
| Zone 6 | 285 |
| Water Addition (milliliters/minute or about 16%) | 90 |
| Die Pressure (PSI) | 300 |

The extrudate was dried in a forced air drier for 20 minutes at 250° F. In another embodiment, the extrudate was placed in a fryer containing heated corn oil at 350° F. for 30 seconds. It will be appreciated by those of ordinary skill in the art that any type of edible or frying oil may be used including, but not limited to, sunflower oil, canola oil, soy oil, peanut oil, cotton seed oil, palm oil, a diacylglycerol oil (i.e., ENOVA brand oil), a low trans oil, a no trans oil, or combinations of any thereof. The finished product had a pleasing flavor and a light crispy texture similar to a puffed snack or cereal. The product is high in fiber as compared to a conventional snack or cereal, and delivers at least 0.4 grams of sterols per serving. After drying or frying, the extrudate may be seasoned such as, for example, by coating the extrudate with a seasoning.

In another embodiment, the nutraceutical used in the extruded product may be, in addition to or in place of the isolated or purified sterols, an isolated or purified lignan (i.e., such as from flax), an isolated or purified glucosamine, an isolated or purified isoflavone, or any combination thereof. In various embodiments, the nutraceutical may be present in concentrations of 0.1-10% or from 1-4%, depending on the desired concentration of the nutraceutical and serving size of the extruded product. For instance, when 2% sterols are added to extruded crisps, a serving size of 20 grams of crisps would be used to obtain 400 mg of sterols per serving of the crisps.

### Example 11

In an additional embodiment, extruded products were prepared with the following formulations:

| | |
|---|---|
| Ingredient | Percentage |

Formulation 1

| | |
|---|---|
| Yellow corn masa | 25.00 |
| Corn meal | 25.00 |
| Navy bean powder (dehydrated) | 32.50 |
| Whole wheat flour | 10.00 |
| Whole pinto beans (dehydrated). | 7.50 |

Formulation 2

| | |
|---|---|
| Yellow corn masa | 50.00 |
| Navy bean powder (dehydrated) | 32.50 |
| Whole wheat flour | 10.00 |
| Whole pinto beans (dehydrated). | 7.50 |

Formulation 3

| | |
|---|---|
| White corn masa | 50.00 |
| Navy bean powder (dehydrated) | 32.50 |
| Whole wheat flour | 10.00 |
| Whole pinto beans (dehydrated). | 7.50 |

The ingredients of the three formulations were blended in a ribbon blender and fed into a Wenger 52 mm twin screw extruder containing a mixture of feeding and kneading elements, as well as forwards and reverse shearlocks. The extruder die had two curved slots and the extrudate was cut using a rotating knife.

The extrusion conditions were as follows:

| | |
|---|---|
| Extruder Screw RPM | 408 |
| PreConditioner RPM | 120 |
| Feeder RPM | 11 |
| | (about 60 lbs/hr) |
| % Motor Load | 32 |
| Rotating Knife RPM | 754 |
| (two blades) | |

Extrusion temperatures, inlet to outlet in ° F.

| | |
|---|---|
| Zone 1 | 147 |
| Zone 2 | 148 |
| Zone 3 | 183 |
| Zone 4 | 232 |
| Zone 5 | 275 |
| Zone 6 | 287 |
| Water Addition (milliliters/minute or about 16%) | 95 |

The extrudates were dried in a forced air dryer for 20 minutes at 250° F., or placed into a fryer containing corn oil at 350° F. for 30 seconds. It will be appreciated by those of ordinary skill in the art that any type of edible or frying oil may be used including, but not limited to, sunflower oil, canola oil, soy oil, peanut oil, cotton seed oil, palm oil, a diacylglycerol oil (i.e., ENOVA brand oil), a low trans oil, a no trans oil, or combinations of any thereof. The forced air dried product and the fried product had a good flavor and a light, crispy texture, similar to corn chips. The extruded products are higher in fiber and protein than conventional corn chip type snacks. After drying or frying, the extrudate may be seasoned such as, for example, by coating the extrudate with a seasoning including, but not limited to, a spice, a salt, a sugar, other known seasoning, and combinations of any thereof.

### Example 12

In yet an additional embodiment, an extruded product was prepared with a dehydrated Navy bean powder available from Archer-Daniels-Midland Company of Decatur, Ill. The dehydrated Navy bean powder includes ground, dehydrated Navy beans, sugar and calcium chloride.

The dehydrated Navy bean powder was placed into the extruder using the following conditions:

| | |
|---|---|
| Extruder Screw RPM | 400 |
| PreConditioner RPM | 145 |
| Feeder RPM | 15 |
| % Motor Load | 55 |
| Knife RPM | 350 |

Extrusion temperatures, inlet to outlet in ° F.

| | |
|---|---|
| Zone 1 | 175 |
| Zone 2 | 160 |
| Zone 3 | 175 |
| Zone 4 | 250 |
| Zone 5 | 285 |
| Zone 6 | 295 |
| Water Addition | 155 |
| Die Pressure | 750 PSI. |

An amount (i.e., 39 grams) of the extruded product has the following nutritional profile: about 1 g of total fat (i.e., about 2.3%); 0 mg of cholesterol; 10 mg of sodium; 26 g of total carbohydrate; 9 g of dietary fiber (i.e., about 22.5%); and 9 g of protein (i.e., about 23%). The extrudate may be seasoned such as, for example, by coating the extrudate with a seasoning including, but not limited to, a spice, a salt, a sugar, other known seasoning, and combinations of any thereof.

### Example 13

In yet an additional embodiment, an extruded product was prepared with 100% dehydrated Navy bean powder available from Archer Daniels Midland Company of Decatur, Ill. The dehydrated Navy bean powder includes ground, dehydrated Navy beans, sugar and calcium chloride.

The product was extruded using the following conditions:

Die plate with 4 - 1 × 3 mm slots-circular cutting blades

| | |
|---|---|
| Extruder RPM | 350 |
| Pre Conditioner RPM | 120 |
| Feeder RPM | 12 |
| % Motor Load | 42 |
| Knife RPM | 3300 |

Extrusion Temperatures, Inlet to outlet in F.

| | |
|---|---|
| Zone 1 | 150 |
| Zone 2 | 155 |
| Zone 3 | 170 |
| Zone 4 | 235 |
| Zone 5 | 265 |
| Zone 6 | 285 |
| Die Pressure | 825 |
| Water Addition, | 290 ml/min |

The density of the food product produced has a density of about 125 grams per liter.

Extruded products can also be produced using substantially the same conditions as disclosed in Example 13 using 100% dehydrated Pinto Bean Powder, 100% dehydrated Red Bean Powder, 100% dehydrated Black Bean Powder, 100% dehydrated Great Northern Bean Powder, or any combinations thereof.

### Example 14

In another embodiment, extruded products produced from any of the Examples disclosed herein may be adhered together using a binder and, optionally, coated or enrobed with a coating, thus producing a snack bar, a nutrition bar or other handheld snack. The extruded products, binder and/or the coating may further contain any of the following components in order to add functionality, texture or taste to the snack or nutrition bar: an enrichment; bulgar flour; calcium citrate; plant sterols such as CARDIOAID brand sterols available from Archer Daniels Midland Company, Decatur, Ill.; a diacylglycerol oil such as ENOVA brand oil available from Archer Daniels Midland Company, Decatur, Ill.; a digestion resistant maltodextrin or soluble fiber such as FIBERSOL brand digestion resistant maltodextrin available from Archer Daniels Midland Company, Decatur, Ill.; a flour such as KANSAS DIAMOND brand whole wheat flour available from Archer Daniels Midland Company, Decatur, Ill.; zero or low trans-fat oil such as NOVA-LIPID brand oil available from Archer Daniels Midland Company, Decatur, Ill.; soy isoflavones such as NOVASOY brand isoflavones available from Archer Daniels Midland Company, Decatur, Ill.; a vitamin such as NOVATOL natural source vitamin E available from Archer Daniels Midland Company, Decatur, Ill.; an artificial sweeter such as, for example, sorbitol; a natural sweetener such as crystalline fructose; soy grits; dry sweeteners; soy flour; an emulsifier such as lecithin; and any combinations thereof.

The binder used to bind the crisps together may include, without limitation, a syrup such as corn syrup or rice syrup. In another embodiment, the binder may comprise the protein-based binder system which includes a protein and a sugar alcohol as described in U.S. patent application Ser. No. 11/473,662 filed on Jun. 23, 2006 entitled Binder for Particulate- and Powder-Type Food Systems and Related Methods assigned to Archer Daniels Midland Company of Decatur, Ill., the contents of the entirety of which is incorporated by this reference.

### Example 15

The food products including the dehydrated legume powders of the present invention are coated or contacted with a seasoning or spice to enhance the flavor. The food product may optionally be coated with a compound for adhering the seasoning or spice to the food product such as, for example, an edible oil, a tack coating, or any other compound capable of adhering the seasoning or spice to the food products. Depending on the desired use of the food product including the dehydrated legume powder, the seasoned or non-seasoned food products are packaged into containers for distribution to customers or are incorporated into a foodstuff, which may be packaged into containers for distribution to customers.

In another embodiment, the container may be an environmentally friendly container that is biodegradable. For instance, the container may comprise a biodegradable polymer comprising a polyhydroxyalkanoate (PHA), which may make the snack contained within the container more appealing to some consumers. The container may be further configured with indicia configured to inform a consumer of the nutritional data of the snack product. For instance, in some exemplary embodiments, the extruded product may be considered to be an “excellent source of fiber,” indicating that the extruded product contains 20-30% of the daily value for total dietary fiber or at least five grams of dietary fiber per FDA (Food and Drug Agency) Reference Amount Customarily consumed. Thus, the container may be associated with indicia configured to inform a consumer of the extruded product of the nutritional value of the extruded product, as well as the biodegradable nature of the container.

The present invention has been described with reference to certain exemplary embodiments, legume powders, compositions and uses thereof. However, it will be recognized by those of ordinary skill in the art that various substitutions, modifications or combinations of any of the exemplary embodiments may be made without departing from the spirit and scope of the invention. Thus, the invention is not limited by the description of the exemplary embodiment, but rather by the appended claims as originally filed.

1. A composition comprising:
a dehydrated legume product having an increased amount of dietary fiber on a dry weight basis as compared to a legume from which the dehydrated legume product originates; and
a flour, a meal, or the flour and the meal;
the dehydrated legume product and the flour, the meal or the flour and the meal being present in the composition in such amounts and processed such that the composition takes the form of a crisp or a puff.

2. The composition of claim 1, further comprising an ingredient selected from the group consisting of a corn product, a wheat product, a rice product, a soy product, a barley product, a sorghum product, a sunflower product, a canola product, an oat product, a flax product, a potato product, a buckwheat product, calcium carbonate, sugar, a seasoning, a spice, a salt, a texture modifier, a vitamin, a mineral, an edible oil or fat, an emulsifier, a leavening agent, a natural or artificial sweetener, a starch, a thickening agent, a soluble fiber, an insoluble fiber, a cellulose, a nutraceutical, a milk product, a whey product, and combinations of any thereof.

3. The composition of claim 1, further wherein the legume from which the dehydrated legume product originates is a bean or a pea.

4. The composition of claim 1, wherein the legume from which the dehydrated legume product originates is selected from the group consisting of yellow peas, green peas, lentils, chickpeas, peanuts, trefoil, Pinto beans, Great Northern beans, Navy beans, Red beans, Black beans, dark or light Red Kidney beans, Fava beans, Green Baby Lima beans, Pink beans, MYASI beans, Mayocoba beans, Small Red beans, Black Eyed Beans, Garbanzo beans, Cranberry beans, White Beans, Rice beans, Butter beans, African Giraffe beans, and combinations of any thereof.

5. The composition of claim 1, wherein the dehydrated legume product makes up at least 10% of the dry weight of the composition.

6. The composition of claim 1, wherein the dehydrated legume product has a particle size of less than 0.250 mm.

7. The composition of claim 1, wherein at least 95% of the dehydrated legume product passes through an 80 mesh screen.

8. A process for producing a product, the process comprising: admixing a dehydrated legume product with an ingredient, thus producing a mixture; and extruding the mixture through a die such that a crisp or a puff is formed.

9. The process according to claim 8, further comprising subjecting the mixture to an elevated temperature.

10. The process according to claim 8, further comprising cutting the extruded mixture with a knife.

11. The process according to claim 8, further comprising incorporating the food product into a foodstuff.

12. The process according to claim 8, further comprising admixing a nutraceutical with the mixture.

13. The process according to claim 8, further comprising adding water to the mixture.

14. The process according to claim 8, wherein extruding the mixture comprises:
heating the mixture; and
subjecting the mixture to an elevated temperature.

15. The process according to claim 8, further comprising placing the crisp or the puff in a container.

16. The process according to claim 8, further comprising:
coating the crisp or the puff with a compound capable of adhering a seasoning or a spice to the crisp or the puff; and
placing the coated crisp or the coated puff in contact with a seasoning or a spice.

17. The process according to claim 8, further comprising adhering a plurality of the crisps or the puffs together with a binder.

18. An extruded food product, consisting essentially of:
a dehydrated bean powder; and
an ingredient selected from the group consisting of a wheat flour, a rice flour, a corn meal, a corn masa, and any combinations thereof;
the extruded food product having a density of between 50 grams per liter to about 250 grams per liter.

19. The extruded food product of claim 18, wherein a surface of the extruded food product is coated with:
a compound capable of adhering a seasoning or a spice to the surface of the extruded food product; and
a seasoning, a spice or a combination thereof.

20. A composition consisting essentially of:
a dehydrated bean powder having an increased amount of dietary fiber on a dry weight basis as compared to a legume from which the dehydrated bean powder originates; and
the dehydrated bean powder being processed such that the composition takes the form of a crisp or a puff.

21-80. (canceled)
